(19) United States
(12) Patent Application Publication
(10) Pub. No.: US 2013/0186630 A1
(43) Pub. Date: Jul. 25, 2013

(54) Low residue formation fracturing

(71) Applicants: Hua Yu, Scarsdale, NY (US); Jian Zhou, Danbury, CT (US); Daniel Bernard Solarek, Hillsborough, NJ (US); Dale Stanley Steichen, Danbury, CT (US)

(72) Inventors: Hua Yu, Scarsdale, NY (US); Jian Zhou, Danbury, CT (US); Daniel Bernard Solarek, Hillsborough, NJ (US); Dale Stanley Steichen, Danbury, CT (US)

(73) Assignee: AKZO NOBEL CHEMICALS INTERNATIONAL B.V., Amersfoort (NL)

(21) Appl. No.: 13/877,790

(22) PCT Filed: Oct. 4, 2011
(86) PCT No.: PCT/EP2011/067257

§ 371 Date: Apr. 4, 2013

(30) Foreign Application Priority Data
Dec. 21, 2010 (EP) 10196234.8

(51) Int. Cl. C09K 8/68; E21B 43/26

(52) U.S. Cl. CPC C09K 8/685; E21B 43/26
USPC 166/308.5; 507/212; 507/201

(57) ABSTRACT

The present invention generally relates to a low residue hydraulic fracturing fluid which comprises an aqueous fluid and at least one polymeric gelling agent, wherein said polymeric gelling agent comprises at least one crosslinked, modified starch. The invention also relates to a method of fracturing a subterranean formation through the use of the aforementioned fracturing fluid.

### FIELD OF THE INVENTION

The present invention generally relates to viscosifier compositions for use in treating subterranean formations. More particularly, the present invention relates to use of a modified starch-based natural polymer system for hydraulic fracturing applications. The invention also relates to a chemical system for use in providing crosslinked modified starches of the invention with low residues after gel break and to oil well fracturing methods utilizing same.

### BACKGROUND OF THE INVENTION

In a subterranean formation with close grained collector rocks of low permeability, the flow of oil to the production well is sometimes low despite very high pressure being involved. In order to facilitate increased flow or increase intake capacity, the rocks in the bottom-hole zone of the reservoir can be subjected to artificial treatments designed to improve their permeability. One of the most effective treatments is hydraulic fracturing.

Hydraulic fracturing is a technique that consists of artificially creating or widening fracturing in the oil-bearing rock formation by injecting a water-based fluid into said formation at high pressure. The resulting fractures extend towards the more remote productive parts of the segment; thus, the productivity of the oil well is increased. In order to prevent fissures clogging or collapsing after the pressure is relieved; a propping agent such as coarse-grained sand suspended in a gelling polysaccharide solution is injected with the fluid into the fracture. Reservoir Stimulation, 3^{rd} ed, John Wiley & Sons, Ltd, 2000.

The expected functions of the fracturing fluid are to initiate and propagate the fracture and to transport the proppant with minimum leakoff and minimal treating pressure. An ideal fracturing fluid should have relatively low viscosity in the tubing (sufficient to carry proppant through the surface equipment but low enough to avoid unnecessary friction pressure losses), and high viscosity within the pressure where a large value can provide bigger fracture width and transport the proppant efficiently down the fracture.

It was reported that around twenty-two different metal ions have been shown to crosslink water-soluble polysaccharides. “Chemical Model for the Rheological Behavior of Crosslinked Fluid Systems”, J. Pet. Tech., Feb. 335 (1983). The excellent thermal and shear stability and salt compatibility make hydroxypropyl- and carboxymethylhydroxypropylguar gum crosslinked with Al³⁺, Zr⁴⁺, and Ti⁴⁺, xanthan gels mediated by Cr³⁺ or NH⁴⁺ and carboxymethylcellulose carboxymethylhydroxyethylcellulose networks the polymers of choice for these operations. The polymer concentration could vary from 15 to 80 lb/1000 gal, depending on the required viscosity. The reaction of these crosslinkers is often delayed so that substantial increase in viscosity takes place near the perforations. This delay reduces the tubing fraction pressure and improves the long-term stability of the viscous fluids.

However, high viscosity fracturing fluids will inadvertently plug the high permeability of the popped fracture, thus create a highly unfavorable mobility. A mechanism to reduce the viscosity after the job to a very low value is then necessary. Gel breakers, such as oxidative compounds (e.g. peroxydisulfates) or enzymes (e.g. hemicellulase) are used to reduce the length of the polymer chains and their molecular weight. Encapsulated breakers are desirable because they became active only when the fracturing treatment is over. Early breaker polymer reaction is detrimental because it degrades the needed viscous properties of the fluid, whereas minimizing or eliminating the breaker is particularly problematic because it could lead to permanent proppant-pack permeability impairment. R. Lapasin and S. Pricl, “Rheology of Industrial Polysaccharides Theory and Applications”, AN Aspen Publication, 1999.

Also, the polymer chains concentrate throughout the treatment as the base liquid leaks off to the formation during the fracturing operation. The concentrated polymer, especially for hydroxypropyl- and carboxymethylhydroxypropylguar gum crosslinked with multivalent metal ions is very difficult to completely break down, even in the presence of breakers. Different combinations of crosslinkers and polymers can be more resistant than others, leading to only partial decomposition, which can result in significant residue and therefore damage the proppant pack permeability and render devastating effects on the fractured well performance.

U.S. Pat. No. 4,659,811 discloses an alkaline refining process for guar gum splits and a fracturing fluid prepared therefrom. The fracturing fluid allegedly has excellent fluid viscosity and low residue after break.

WO 2006/109225 discloses the use hydrophilic modified polysaccharide (guar gum) to prepare the fracturing fluids resulting in very low residue in the formation after treatment.

U.S. Pat. No. 5,681,796 discloses the preparation of fracturing fluids with a low concentration of the guar gum, which are being able to crosslink with multivalent metal cations under special buffered condition and deliver required viscosity for fracturing and low residue after break.

U.S. Pat. No. 4,946,604 discloses the use of non reducing sugar together with guar gum to prepare the fracturing fluids with controlled viscosity reducing (gel breaking) performance.

U.S. Pat. Nos. 5,881,813 and 5,547,026 teach the use enzymes to break the crosslinked polysaccharide based well treatment fluids with low residue for better cleanup.

U.S. Pat. No. 4,169,798 teaches the use of methyl ester guar gum based well treatment fluids with enzymes (i.e. hemicellulase) as breaker to afford better gel breakup and cleanup efficiency. However, maintaining high temperature performance of the enzyme based breakers is still a big issue for today's high temperature fracturing applications.

U.S. Pat. Nos. 6,983,801 and 5,460,226 teach new gel breaking system for guar gum based fracturing fluids that incorporate hydrolysable ester to lower the pH and enhance the further de-crosslinking of the polysaccharide gels with low residue. U.S. Pat. Nos. 7,331,389, 7,311,145, and 6,488,091 further teach the method to re-use the de-linked guar gum gels with similar approaches.

U.S. Pat. No. 6,810,959 discloses new cationic hydroxyethylcellulose based fracturing fluids that allegedly generate low residue after break. This patent also discloses that the hydrophilic groups on the modified polysaccharide are the reason for the low residue after break as the broken polysaccharide fragments are allegedly easier to dissolve in an aqueous liquid.

### SUMMARY OF THE INVENTION

The present invention generally relates to viscosifier compositions for use in treating subterranean formations. More particularly, the present invention relates to use of modified starch-based natural polymer system for hydraulic subterranean formation fracturing applications. The invention also relates to a chemical system for use in providing crosslinked modified starches of the invention with minimal or no residue in the treated subterranean formation after gel break and to oil well fracturing methods utilizing same.

### DETAILED DESCRIPTION OF THE INVENTION

The present invention relates to a low residue hydraulic fracturing fluid that comprises an aqueous fluid, polymeric gelling agent comprising one or more hydratable modified starches. The fracturing fluid of the invention can additionally comprise a crosslinker composition, a gel breaker, and/or proppant. The low residue hydraulic fracturing fluids of the present invention may also contain other components and additives, including without limitation, clay stabilizer, surfactants, fluid loss control agents, oxygen scavengers, etc. and the like.

An aqueous fluid is used to hydrate the gelling agent prior to crosslinking. The aqueous fluid can be fresh water or brine. If salt water, it usually contains 0.01 to 13% of salts by weight of the fluid, preferably, 0.5 to 7% of salts by weight of the fluid. The salt water can be natural or synthetic brine, seawater, or the water containing any inorganic or organic salt components which are not detrimental to the active ingredients and the performance of the fluids.

A hydratable, modified starch is a water soluble polysaccharide which can be further crosslinked with multivalent metal ion to afford excellent thermal and shear stability as well as salt compatibility. The starch used in preparing the present invention may be any starch derived from any variety of native source, including without limitation, corn (maize), potato, barley, wheat, tapioca, as well as low amylose (waxy) and high amylose varieties thereof. A preferred starch is high molecular weight waxy potato or maize starch which contains less than 10% amylose by weight of the starch, in another embodiment less than 5% amylose by weight of the starch, in another embodiment less than 2% amylose by weight of the starch, and in yet another embodiment less than 1% by weight of the starch. The molecular weight of the hydratable modified starch employable in the invention can be anywhere between 100,000 to 500 million, in another embodiment between 500,000 to 200 million.

The modified starch was prepared from a reaction of starch and alkyleneoxide, followed by crosslinking same with a polyfunctional crosslinking agent. In addition to chemical modification with alkylene oxide, other means for modification such as the use of other chemical reagents, heat, and the like can be employed in order to modify same.

The alkylene oxides employable for modification of the starch are of the following general formula:

(—O—R₁—)_{y}

wherein each R₁ is independently selected from alkylene groups containing up to 4 carbon atoms and y is between about 1 and about 3000.

The modified starch was prepared from a reaction of starch and alkyleneoxide, followed by crosslinking same with a polyfunctional crosslinking agent. In one embodiment of the invention, the starch is modified with alkoxylated nonionic substituent groups. When the alkoxy modifying groups are attached to starch via an ether linkage the reactive reagent comprises a halide, halohydrin, epoxide or glycidyl group. In one embodiment, the crosslinking agents are chosen from sodium trimetaphosphate, phosphorus oxychloride, epichlorohydrin and mixtures thereof. Alternatively heating the dry modified starch powder under specific conditions of pH and temperature can physically modify the starch to function similarly to a covalently crosslinked starch.

The nonionic alkoxy substituent groups employable for modification of the starch are of the following general formula: —CH₂—CH (OH) R
where R═H, CH₃ or —CH₂—CH₃.
   In one embodiment, the alkylene oxides employable for starch modification include, but are not limited to ethylene oxide, propylene oxide, and butylene oxide.

The polyfunctional crosslinking agent can be any organic or inorganic compounds containing polyfunctional groups that can react to the hydroxyl groups on starch polysaccharide backbone. Useful crosslinkers include, but are not limited to, phosphorus oxyhalides, sodium trimetaphosphate, sodium polyphosphate, glyoxal, epicholohydrin, diglycidylether type of diepoxy compounds, diepoxybutene, compounds containing poly N-methanol groups, mixtures thereof and the like.

Generally, from about 0.1 to 30 weight % of alkyleneoxide based on the weight of the starch and 1 to 1000 ppm of crosslinking agent based on the weight of the starch, is employed to modify the starch. In another embodiment from about 1 to 15% of alkyleneoxide by weight of the starch and 5 to 500 ppm of crosslinker by weight of the starch, are used to modify the starch.

After (chemical) modification, the modified/crosslinked starches are then spray-dried to pregelatinize using a steam injection/dual- or single atomization process to afford better cold water/brine dispersability. These processes are known and well described in U.S. Pat. Nos. 4,280,851, 4,600,472, and 5,149,799, both of which are incorporated herein by reference.

For fracturing applications, the fluid generally comprises from about 0.1 to 20 Weight % of starch by weight of the fluid, in another embodiment, from about 0.5 to 5 Weight % of starch by weight of the fluid.

A crosslinker composition may comprise a multivalent metal ion based inorganic or organic chemical compounds, including without limitation, boron, aluminum, ion, zirconium, chromium, titanium. Generally, from about 0.01 to 10% of crosslinker by weight of the fluid, in another embodiment from about 0.05 to 4% of crosslinker by weight of the fluid, are used for fracturing applications depending upon the temperature of the formation to be fractured and the type of the crosslinker.

A gel breaker is used in accordance with the invention may contain, including without limitation, oxidizers, enzyme, bases, or acids. Generally, from about 0.01 to 20% of gel breaker by weight of the fluid, in another embodiment from about 0.05 to 10% of gel breaker by weight of the fluid, are used for fracturing applications depending upon the temperature of the formation to be fractured and the type of the breaker.

In order to perform a fracturing operation on a subterranean formation according to the present invention, the modified starch based polymeric gelling agent is dispersed into an aqueous fluid at temperature of from about 0.5 to 70° C., in another embodiment at approximately ambient temperature with minimum agitation. Upon the hydration of starch, the fluid begins building viscosity. The source of crosslinker, the breaker, the proppants, and other additives are then added to the thickened fluid. The viscosity of the thickened fluid can be as high as 10,000 cp at 1/100s shear rate depending upon the usage levels of the starch and crosslinker. The thicken fluid is then injected into and placed in the wellbore at high pressure, and subsequently, the pressure on the fluid is increased to a pressure that exceeds the formation fracturing pressure, and thus, the formation is thereby fractured. The resulting fractures extend towards the more remote productive parts of the oil rich segment; thus, the permeability and hence productivity of the oil well is increased. As thickened fracturing fluid together with proppant-pack can plug the popped fracture affecting the permeability thereof, a gel breaker can optionally be employed to reduce the viscosity to a very low value with very low residue, leaving the proppant in place to hold the fracture open. Encapsulated breakers are desirable because they became active only when the fracturing treatment is over.

The performance properties of low residue hydraulic fracturing fluid of the present invention will now be exemplified by the following non-limiting examples.

### EXAMPLE 1

### Preparation of Propylene Oxide Modified And Phosphorus Oxychloride Cross-Linked Waxy Starch Derivatives

Waxy starch (1000 g) was slurried in an aqueous solution of sodium sulfate (200 g in 1500 g of water) at room temperature. To the stirred slurry, 3% solution of sodium hydroxide (500 g) was slowly added; at which point the pH of the slurry should be at least 11.50 (or 25 mL of reaction slurry should require 25-30 mL of 0.1N aqueous hydrochloric acid to neutralize at the phenolphthalein end-point). Propylene oxide (70 g or 7% on weight of starch) was added to the slurry and the reaction mixture was allowed to react at 40° C. for at least 16 h. The post-reaction slurry was then cooled to room temperature and its alkalinity was checked and adjusted, if necessary, to the above-described end-point using 3% solution of sodium hydroxide as needed. Phosphorus oxychloride (0.05 g or 0.005% ows) was then added and the mixture was allowed to react for an additional 1 h. The final reaction mixture was neutralized to a pH of 5.5 with a 10% solution of hydrochloric acid. The modified starch was then filtered, washed and dried.

A sample of the modified/cross-linked waxy starch was analyzed to determine its peak viscosity using a C. W. Brabender Visco-Amylo Graph according to Test (A) and found to have a peak viscosity of 1100 Brabender Units.

The modified/cross-linked waxy starch was then slurried in water to 20-30% anhydrous solids by weight and spray-dried to pregelatinize using a steam injection/dual- or single atomization process or called pre-agglomeration process.

A sample of the pregelatinized modified/crosslinked waxy starch was then further analyzed to determine its peak viscosity using a C. W. Brabender Visco-Amylo Graph according to Test (B) and found to have a peak viscosity of 2700 Brabender Units.

TABLE 1
Preparation of Modified Waxy Starches

| | | Molecu- | | | |
|---|---|---|---|---|---|
| | | lar | With PO | With POCl₃ | With Pre- |
| | Base | Weight | Modification | Crosslinking | agglomeration |
| Starch | Waxy | 90-100 | Yes | Yes | Yes |
| #1 | maize | million | | | |
| Starch | Waxy | 95-110 | Yes | Yes | No |
| #2 | Potato | million | | | |
| Starch | Waxy | 75 | Yes | No | No |
| #3 | Maize | million | | | |
| Starch | Waxy | 200,000 | No | No | No |
| #4 | maize | | | | |

### EXAMPLE 2

### Viscosity Profiles of Modified Waxy Starches In 2% KCl Solution

Modified waxy starch was dispersed in 2% KCl solution with mixing. The viscosity of the starch solution is measured by either Brookfield Model DV-III Programmable Rheometer or Grace M3600A-2 High Temperature and High Pressure Rheometer.

TABLE 2
Viscosity of Modified Waxy Starch solution with 2% KCl at 25° C.

| | Concentration (wt %) in | Dispersability | Viscosity |
|---|---|---|---|
| | 2% KCl | in 2% KCl solution | (cP, 1/100 s) |
| Starch #1 | 2.7 | Excellent | 70.4 |
| Starch #2 | 2.5 | Slow | 38.4 |
| Starch #3 | 8 | Moderate | 83 |
| Starch #4 | 19 | Moderate | 29 |

### EXAMPLE 3

### Viscosity Profiles of Modified Waxy Starches Crosslinked With Boric Acid Or AlCl₃ In 2% KCl Solution

Modified waxy starch was dispersed in 2% KCl solution with mixing. After pH adjustment, aqueous solution of either boric acid or AlCl₃ is slowly added to the starch solution. The viscosity of crosslinked starch solution is measured by Brookfield Model DV-III Programmable Rheometer.

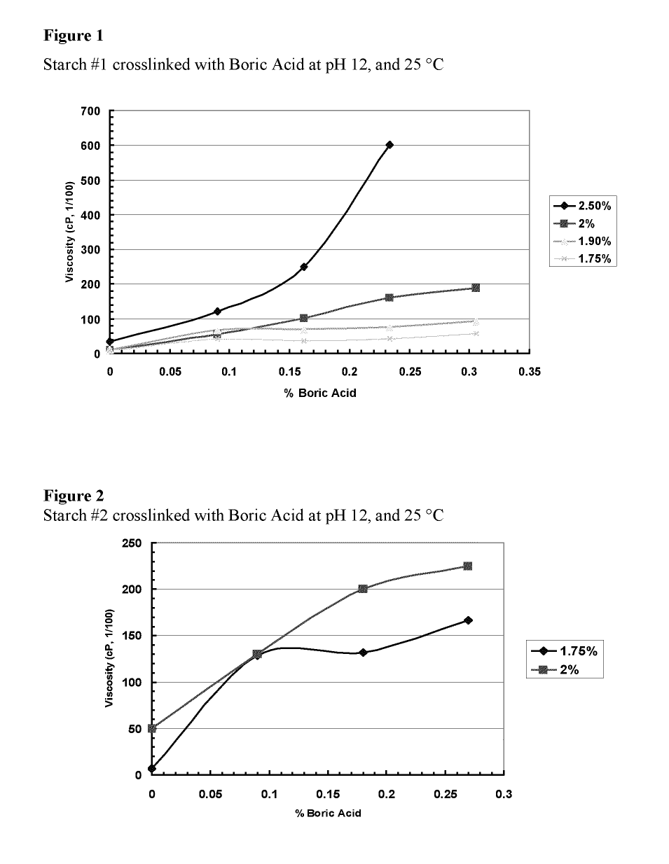

The results for Starch #1 crosslinked with Boric Acid at pH 12, and 25° C. is depicted in FIG. 1.

The results for Starch #2 crosslinked with Boric Acid at pH 12, and 25° C. is depicted in FIG. 2.

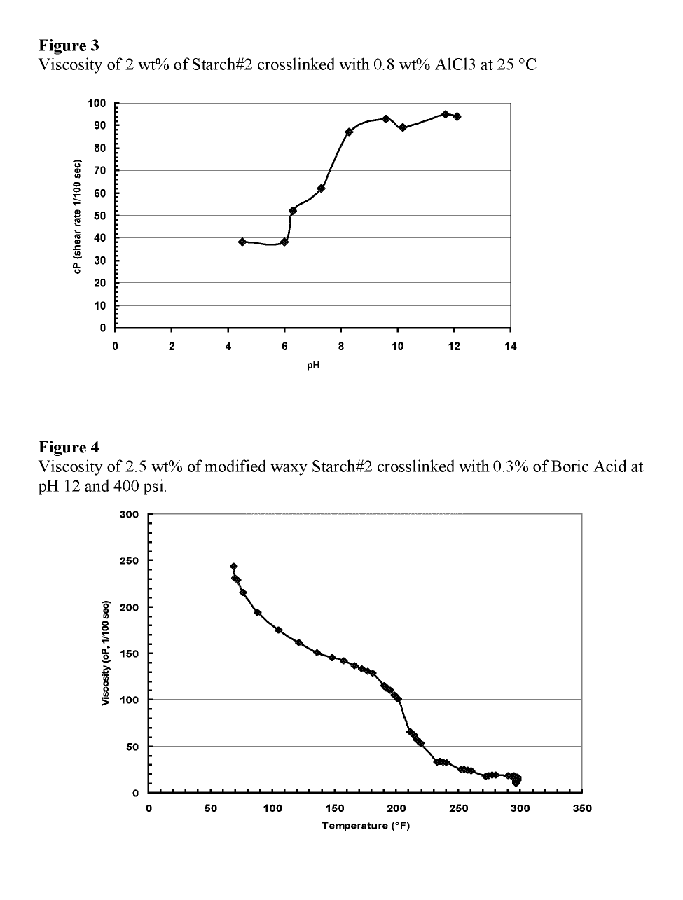

The viscosity of 2 wt % of Starch #2 crosslinked with 0.8 wt % AlCl3 at 25° C. is depicted in FIG. 3

### EXAMPLE 4

### High Temperature High Pressure (HTHP) Viscosity Profiles of Modified Waxy Starches In 2% KCl Solution

Modified waxy starch was dispersed in 2% KCl solution with mixing. After the pH adjustment, aqueous solution of metal ion crosslinker is slowly added to the starch solution. The HTHP viscosity of the starch solution is measured by Grace M3600A-2 HTHP Rheometer.

The viscosity of 2.5 wt % of modified waxy Starch #2 crosslinked with 0.3% of Boric Acid at pH 12 and 400 psi is depicted in FIG. 4.

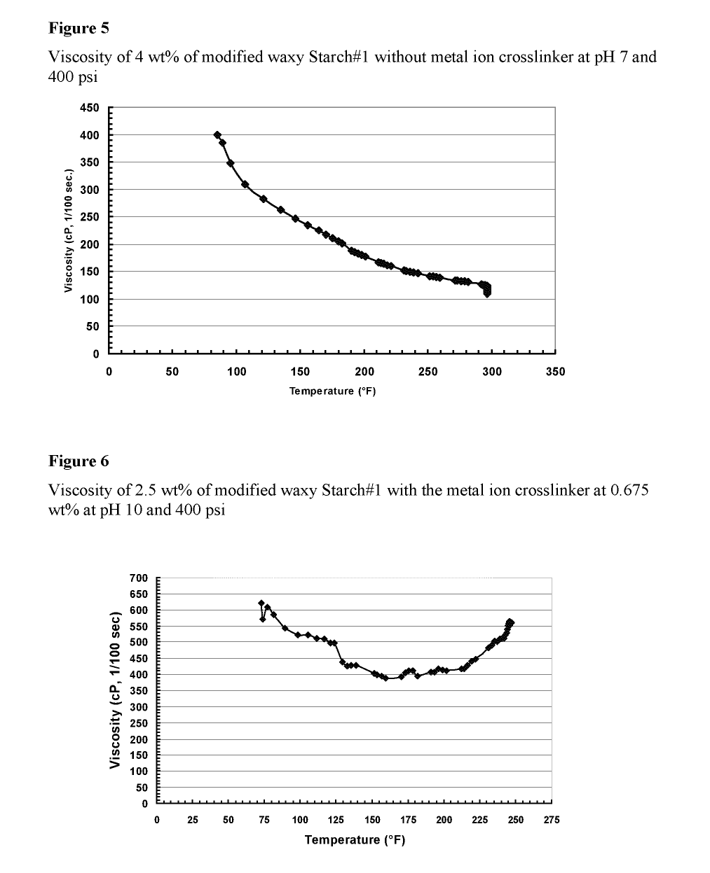

The viscosity of 4 wt % of modified waxy Starch #1 without metal ion crosslinker at pH 7 and 400 psi is depicted in FIG. 5.

The viscosity of 2.5 wt % of modified waxy Starch #1 with the metal ion crosslinker at 0.675 wt % at pH 10 and 400 psi is depicted in FIG. 6.

### EXAMPLE 5

### Modified Waxy Starch Crosslinked With Boric Acid At pH 12 Treated With Ammonium Persulfate Gel Breaker

2.5 wt % of modified waxy Starch was dispersed in 2% KCl solution at pH 12 with mixing. 1.22% (by the weight of starch) of aqueous solution of boric acid crosslinker is slowly added to the starch solution and the solution viscosity increases. Upon the viscosity of starch solution stabilizes, 0.6% of ammonium persulfate was slowly added into the thicken solution while stirring. The mixture was then stirred for one hour at 50° C. ready for filtration test.

For comparison, 0.5 wt % of commercial guar gum was dispersed in 2% KCl solution at pH 12 with mixing. 0.45% (by the weight of guar gum) and 0.63% (by the weight of guar gum) of aqueous solution of boric acid crosslinker is slowly added to the guar gum #1 and guar gum #2 solution, respectively, and the solution viscosity increases. Upon the viscosity of guar gum solution stabilizes, 0.6% of ammonium persulfate was slowly added into the thicken solution while stirring. The mixture was then stirred for one hour at 50° C. ready for filtration test.

The viscosity of the polysaccharide gels solution is measured by Brookfield Model DV-III Programmable Rheometer.

The filtration test of the crosslinked starch solution before and after ammonium persulfate treatment was conducted at ambient temperature with 300 psi of back pressure similar to the American Petroleum Institute (API) Recommended Practice 13B (RP 13B), 12^{th} Ed (Sep. 1, 1988), on Section 3.4 of High-Temperature/High-Pressure Filtration Test, p11-13, with exception of using Whatman grade #4 filter paper with pore size of 20-25 μm.

TABLE 3
Pressure filtration results of crosslinked modified startches and
guar gum before and after ammonium persulfate treatment

| | | | Solution | | | |
|---|---|---|---|---|---|---|
| | | | Passing | | Polymer | |
| | | | through the | | residue on | |
| | | | filter paper (%, | | filter paper | |
| | Viscosity | | by weight | | (%, by weight | |
| | (cP, 1/100 s) | | of solution) | | of polymer) | |
| | Before | After | Before | After | Before | After |
| Starch #1 | 400 | 0 | 87 | 100 | 17 | 2 |
| Starch #2 | 900 | 0 | 91 | 100 | 13 | 1 |
| Guar Gum #1 | 1400 | 3 | 51 | 93 | 100 | 44 |
| Guar Gum #2 | 800 | 3 | 67 | 94 | 100 | 40 |

1. A low residue hydraulic fracturing fluid which comprises an aqueous fluid and at least one polymeric gelling agent, wherein said polymeric gelling agent comprises at least one crosslinked, modified starch
wherein the crosslinked, modified starch is modified using about 1 to 15% of alkyleneoxide by weight of the starch and about 5 to 500 ppm of crosslinking agent based on the weight of the starch,
wherein the fracturing fluid comprises from about 0.5 to 5% of the crosslinked, modified starch based on the weight of the fracturing fluid, and
wherein the fracturing fluid increases in viscosity when the aqueous fluid comes in contact the polymeric gelling agent.

2. The fracturing fluid of claim 1 which additionally comprises a gel breaker, proppant, or both gel breaker and proppant.

3. The fracturing fluid of claim 1 wherein said crosslinked, modified starch is derived from the reaction of hydratable starch and at least one alkylene oxide to obtain a modified starch, followed by crosslinking said modified starch with at least one polyfunctional crosslinking agent in order to obtain a crosslinked, modified starch.

4. The fracturing fluid of claim 3, wherein said starch is derived from corn (maize), potato, barley, wheat, tapioca, or mixtures thereof.

5. The fracturing fluid of claim 4, wherein said starch is high molecular weight waxy potato or maize starch which contains less than 10% amylose by weight of the starch.

6. The fracturing fluid of claim 3, wherein said alkylene oxide is selected from the group consisting of ethylene oxide, propylene oxide, butylene oxide and combinations or mixtures thereof.

7. The fracturing fluid of claim 1, wherein the molecular weight of the hydratable modified starch is from about 100,000 to 500 million.

8. The fracturing fluid of claim 1, wherein at least one polyfunctional crosslinking agent is selected from the group consisting of phosphorus oxyhalide, sodium trimetaphosphate, sodium polyphosphate, glyoxal, epicholohydrin, diglycidylether type of diepoxy compounds, diepoxybutene, compounds containing poly N-methanol groups, and combinations or mixtures thereof.

9. The fracturing fluid of claim 1 further comprising a crosslinker composition, wherein the crosslinker composition comprises a multivalent metal ion based inorganic or organic chemical compounds.

10. The fracturing fluid of claim 9, wherein the multivalent metal is selected from the group consisting of boron, aluminum, iron, zirconium, chromium, and titanium.

11. The fracturing fluid of claim 1, wherein said crosslinked, modified starch is spray dried.

12. The fracturing fluid of claim 1, wherein said polymeric gelling agent additionally comprises at least one gel breaker, which is optionally encapsulated and becomes active only when fracturing is completed.

13. The fracturing fluid of claim 12 which comprises 0.01 to 20% gel breaker based on the weight of the fluid.

14. A method of fracturing an underground formation which comprises injecting the fracturing fluid of claim 1 into said formation at pressures sufficient to fracture said formation, followed by breaking the viscosity of said fluid in order to obtain a fractured formation with improved permeability.

15. The method of claim 14 wherein said polymeric gelling agent is spray dried prior to combining same with said aqueous fluid.

16. The fracturing fluid of claim 12 wherein said gel breaker is selected from the group consisting of oxidizers, enzymes, acids, bases, and combinations or mixtures thereof.

17. The method of claim 14 wherein said fracturing fluid comprises an aqueous fluid and at least one polymeric gelling agent, wherein said polymeric gelling agent comprises at least one crosslinked, modified starch, said fracturing fluid optionally comprising a gel breaker, proppant, or both gel breaker and proppant.

18. The method of claim 14 wherein said crosslinked, modified starch is derived from the reaction of hydrated starch with at least one alkylene oxide to obtain a modified starch, followed by crosslinking said modified starch with at least one polyfunctional crosslinking agent in order to obtain a crosslinked, modified starch.

19. The method of claim 18 wherein said starch is derived from corn (maize), potato, barley, wheat, tapioca, or combinations or mixtures thereof.

20. The method of claim 18 wherein said alkylene oxide is selected from the group consisting of ethylene oxide, propylene oxide, butylene oxide, and mixtures thereof.

21. The method of claim 18 wherein at least one polyfunctional crosslinking agent is selected from the group consisting of phosphorus oxyhalide, sodium trimetaphosphate, sodium polyphosphate, glyoxal, epicholohydrin, diglycidylether type of diepoxy compounds, diepoxybutene, compounds containing poly N-methanol groups, and combinations or mixtures thereof.

22. The method of claim 18 wherein from about 0.1 to 30% weight % of alkyleneoxide based on the weight of the starch is employed to modify said starch.

23. The method of claim 18 wherein from about 1 to 1000 ppm of crosslinking agent based on the weight of the starch is employed to crosslink said modified starch.

24. The method of claim 14 wherein said fracturing fluid comprises 0.01 to 20% breaker based on the weight of the fluid.
